(19) United States
(12) Patent Application Publication
(10) Pub. No.: US 2022/0153460 A1
(43) Pub. Date: May 19, 2022

(54) METHOD AND APPARATUS FOR PACKAGING RESPIRING PRODUCE

(71) Applicant: PERFO TEC B.V., Woerden (NL)

(72) Inventors: Paulus Josephus Benedictus VAN DE LOO, Woerden (NL); Bastiaan Rinke Antony GROENEWEG, Woerden (NL); Arthur BROUWER, Woerden (NL); Martijn Willem DE BRUIN, Woerden (NL)

(73) Assignee: PERFO TEC B.V., Woerden (NL)

(21) Appl. No.: 17/440,489

(22) PCT Filed: Mar. 20, 2020
(86) PCT No.: PCT/NL2020/050192

§ 371 Date: Sep. 17, 2021

(30) Foreign Application Priority Data
Mar. 21, 2019 (NL) 2022786
Jun. 18, 2019 (NL) 2023336

(51) Int. Cl. B65B 25/04; B65B 31/02; B65B 61/02; B65B 25/02; A23L 3/3445; A23B 7/152

(52) U.S. Cl. CPC B65B 25/041; B65B 31/028; A23B 7/152; B65B 25/023; A23L 3/3445; B65B 61/02

(57) ABSTRACT

A method of packaging respiring produce comprises the steps of:providing a portion of packaging material, in particular a polymeric packaging material;providing a portion of the produce;forming, from the portion of packaging material and the portion of the produce, a closed package defining a package volume and containing in the package volume the portion of produce and a modified atmosphere; wherein the modified atmosphere is modified with respect to the ambient atmosphere. The method further comprises generating an atmosphere modification gas and/or an atmosphere modification gas mixture and/or establishing a modified atmosphere having an elevated ozone concentration in the package volume. An associated apparatus is also provided.

The present disclosure relates to packaging of respiring produce, in particular flowers, flower bulbs, vegetables, fruits and/or herbs, more in particular cut flowers and minimally processed vegetables and/or -fruits and/or -herbs.

### BACKGROUND

Shelf life of natural products is of interest to producers, sellers, re-sellers and consumers alike. In the case of flowers, particular concern is the so-called vase life, the time cut flowers and/or flowers in a bouquet retain acceptably pleasing appearance and/or fragrance on display. Typically the vase life is a few days up to about two weeks at most.

Shelf life and vase life are affected by initial produce quality and by conditions of storage and/or transport.

Natural produce such as flowers, vegetables, fruits and/or herbs tend to respire after being harvested. The respiration continues for prolonged periods, in particular if the produce has undergone little to no processing, e.g. having been washed and possibly peeled and/or chopped up, but otherwise fresh and uncooked. When such produce is packaged, the atmosphere within the package is affected by the respiring produce. Conversely, an atmosphere surrounding produce affects the respiration, maturation, aging and/or deterioration of the packed produce.

It has therefore become customary to package fresh produce in packages with a modified atmosphere (Modified Atmosphere Package or MAP) or with a controlled atmosphere (Controlled Atmosphere Package or CAP). In MAP the produce is packaged and an artificial gas mixture is used to establish a distinct interior atmosphere in the package, which may however change later on due to the respiration of the packed produce. In CAP the produce is packaged and the composition of the package atmosphere is controlled by including an active absorber for an atmosphere component, e.g. an oxygen scavenger or by adapting transmission of the packaging material to allow exchange with an exterior atmosphere outside the package. Modified- and controlled atmosphere packaging (MAP/CAP) preserve produce quality by reducing the aerobic respiration rate but avoiding anaerobic processes that may lead to adverse changes, e.g. in one or more of colour, texture, flavour and aroma.

E.g., as explained in U.S. Pat. No. 7,083,837, the quality and shelf life of many food products is enhanced by enclosing them in packaging that modifies or controls the atmosphere surrounding the product. Increased quality and longer shelf life result in fresher products for the consumer, less waste from spoiled produce, better inventory control, and appreciable overall savings for the food industry at both the retail and wholesale levels. U.S. Pat. No. 7,083,837 discusses that in MAP, sometimes the package is gas-flushed with N₂ or a combination of CO₂ and N₂, or a combination of O₂, CO₂, and N₂ before sealing the package to rapidly establish the desired gas composition inside the package. U.S. Pat. No. 7,083,837 further discusses that in CAP the package may (micro-)perforated. Providing packages and packaging material with perforations is also disclosed in, e.g., EP 0 351 115, WO 93/22207, U.S. Pat. Nos. 6,441,340, 6,730,874, WO 02/12068, US 2003/029850, WO 2006/063609, FR 2,873,992, WO 2009/132663 and EP 1 935 787, and in scientific literature such as L. Jacxsens et al, “Validation of a systematic approach to design equilibrium modified atmosphere packages for fresh-cut produce”, Lebensm. Wiss. u. Technol. 32:425-432 (1999), C. Sanz et al, “Quality of strawberries packed with perforated polypropylene” J. Food Sci. 64:748-752 (1999) and J. G. Kim et al, “Effect of initial oxygen concentration and film oxygen transmission rate on the quality of fresh-cut romaine lettuce”, J. Sci. Food. Agric. 85:1622-1630 (2005).

WO 2014/129904 discloses that a combination of MAP and CAP may be used.

It has now been found that due to the improvements in CAP and MAP, afflictions by spores and germs that were previously largely irrelevant now become decisive in determining shelf life and/or vase life.

It is further noted that ozone has been found a suitable disinfectant for natural products such as respiring produce as indicated above, e.g. see WO 98/16428, U.S. Pat. Nos. 6,210,730, 7,644,560, or T. Suslow, “Ozone applications for postharvest disinfection of edible horticultural crops”, ANR Publication 8133 (2004) (University Of California, Division of Agriculture and Natural Resources).

However, ozone is a highly reactive gas which cannot easily be stored, and elevated ozone levels may do more harm than good to natural products, possibly being damaging. Handling of ozone and treatment of produce with ozone therefore require care.

Improved Modified Atmosphere Packages and methods of producing them more cost-efficient are therefore desired.

### SUMMARY

In view of the preceding, herewith methods and apparatus of treating and/or packaging respiring produce according to the present disclosure, and in particular according to the appended claims, are provided.

An aspect is a method of packaging respiring produce, comprising the steps of:

providing an apparatus for manufacturing a modified atmosphere package;

providing a portion of packaging material, in particular a polymeric packaging material;

providing a portion of the produce;

forming, using the apparatus, from the portion of packaging material and the portion of the produce, a closed package defining a package volume and containing in the package volume the portion of produce and a modified atmosphere;

wherein the modified atmosphere is modified with respect to the ambient atmosphere.

The method further comprises generating a gas with the apparatus being one or more concentrated, enriched and/or purified gases or gas mixtures, compared to ambient air and establishing the modified atmosphere on the basis of the generated gas.

Generation of the gas with the apparatus, which may mean generation on-site and/or on-line, facilitates one or more of optimisation of generation rate and/or composition of the gas; provision of fresh gases thus preventing possible contamination and/or reaction of the gas; reduction of complexity and/or costs of logistics of (constituent) gases e.g. transport and/or storage of gas bottles.

The step of generating the gas may comprise taking in ambient air and generating from the air taken in at least one of the atmosphere modification gases and/or an atmosphere modifying gas mixtures for establishing the atmosphere modifying gas mixture. Generation of the gas from ambient air reduces or even obviates procurement and/or logistics issues. Note that natural produce clearly is adapted to ambient air and a modified atmosphere may be established by separation and/or selective removal of one or more components from the ambient air, and/or formation of one or more particular components and possibly by re-mixing the generated gases or gas mixtures in predetermined amended ratios.

The step of generating the gas may comprise generating an atmosphere modification gas being essentially nitrogen, oxygen, argon, carbon dioxide or ethylene. Here, “essentially” means that the generated gas has a concentration of over 99% purity of the respective substance by volume, preferably well over 99% such as over 99,5% or over 99,8% or even higher. E.g. commercially available gas generators may generate, from ambient air, nitrogen with a purity of about 99,9% and higher, e.g.

99,99%, 99,999% or even still higher, at rates of several cubic meters per hour at standard room temperature and pressure (e.g. about 300K, 1 atmosphere). Similar holds for (generation of) oxygen. The higher the purity of the gas, the better it may be for providing a modified atmosphere with a predetermined composition. It has been found that the operation of such gas generators is sufficiently reliable that they may be used in a produce packaging environment and that the costs of procurement and operation may outweigh costs of logistics and/or storage, and such outweighing may occur significantly faster than previously considered possible if considered possible at all.

Moreover, in case the gas generation comprises separation of gases from ambient air, particularly relevant components may become readily accessible; commercially available gas generators are generally considered as nitrogen generators, with oxygen and other air components being considered waste products. Yet, the oxygen may also be obtained from such nitrogen gas generator at high purity. Similarly, some commercially available gas generators are generally considered as oxygen generators with nitrogen and other air components being considered waste products, and the nitrogen may be obtained from such oxygen gas generator at high purity. The respective separated and/or high-purity gases may be suitably employed for establishing a modified atmosphere having a well-controlled oxygen concentration that may be lower than that of ambient air and/or a nitrogen concentration that may be higher than that of ambient air, by mixing the generated nitrogen and oxygen together again at a different ratio than in ambient air. A further benefit may then be that locally generated oxygen may obviate procurement and/or logistics of pure oxygen, which is well known to be problematic e.g. requiring special permits and safety measures. The same applies likewise to other gases separable from ambient air, e.g. argon and/or carbon dioxide.

The method may comprise generating a gas with the apparatus wherein the gas comprises ozone or essentially is ozone, and wherein the method further comprises establishing a modified atmosphere in the package having an elevated ozone concentration in the package volume. The ozone may be generated inside the package, possibly after the package is closed, which closing may comprise stapling, stitching, sealing, glueing, welding etc. Ozone generation inside the package may comprise generating a plasma within the package volume, e.g. by applying a high electric field within the package volume and/or irradiating the package atmosphere with high-energy electromagnetic radiation like ultraviolet light. A high electric field may be formed between electrodes at least one of which possibly being at least partly introduced into the package volume or a package volume-to-be-formed, and/or by creating a corona discharge within the package volume. Suitable techniques an electrodes for these are known.

The ozone may be generated from oxygen generated by the gas generation step.

Associated therewith is another aspect of the present principles: a method comprising the steps of:

providing a portion of packaging material, in particular a polymeric packaging material;

providing a portion of the produce;

forming, from the portion of packaging material and the portion of the produce, a closed package defining a package volume and containing in the package volume the portion of produce and a modified atmosphere;

wherein the modified atmosphere is modified with respect to the ambient atmosphere;

wherein the method comprises establishing a modified atmosphere in the package volume having an ozone concentration of at least 3 ppm at the time of closing the package, preferably at least 5 ppm more preferably at least 7 ppm such as 10 ppm. Higher concentrations tend to result better decontamination and better shelf life and/or vase life.

According to the presently provided principles, the package atmosphere is modified with a modification gas comprising an elevated concentration of ozone. This kills, or at least hinders growth of, contaminants, in particular bacteria and/or fungi, most notably botrytis, E. coli and Salmonella.

The ozone may be introduced as a pure gas or in combination with other gases, e.g. being mixed with nitrogen, argon, oxygen and/or pressurised air. The latter is relatively cheap compared to pure gases or pure gas mixtures. By introducing ozone into the package, sanitisation prior to packaging is obviated and the risk of (re-)contamination in a time period between ozone treatment and closing the packaged is prevented. Thus, the packaging process may be better controlled and accelerated.

By providing the ozone into the package, the decontamination extends for a prolonged duration also after packaging. This obviates time for a separate decontamination step and speeds up the process of packaging. Further, the packaging material is also decontaminated.

Respiring produce tends to produce ethylene, which is a ripening gas that stimulates ripening and further formation of ethylene. Ozone assists in dissociating ethylene, therewith hindering the feedback process and decelerating ripening.

Ozone tends to dissociate over time in a matter of hours to minutes (half life). Therefore, at normal shipping and handling times all ozone has disappeared at the moment of opening the package by a consumer.

Since the ozone (O₃) will dissociate to oxygen (O₂), the amount of ozone introduced into the package preferably is taken into account in determining the amount of oxygen introduced into the package. A possible manner of doing so is by providing an amount of oxygen in the package at the time of sealing the package and defining the modified package atmosphere less than a predetermined amount of oxygen, in particular an optimum amount for MAP, and providing a predetermined amount of ozone in the package at the time of sealing the package which, on dissociation to oxygen, will result in complementing the modified package atmosphere to the predetermined amount of oxygen, i.e. making up the intentional offset deficit oxygen concentration. Also or alternatively, a manner of doing so is by providing a predetermined amount of oxygen, and/or a gas mixture containing a predetermined amount of oxygen, for introduction into a package and converting part of the predetermined amount of oxygen to ozone and introducing a thus-formed gas mixture containing ozone and remaining oxygen into the package. Such manner may comprise operating an ozone converter on a portion of a gas mixture containing oxygen and one or more further gases.

Preferably, the ozone concentration is at most 5000 ppm at the time of closing the package, preferably at most 3000 ppm more preferably at most 1000 ppm. Too high ozone concentrations may negatively affect the produce and counteract gains of (attempted) further decontamination, e.g. by rendering the produce more sensitive to any remaining germs or spores. Thus, the ozone concentration has an optimum in the range 3-5000 ppm, preferably in the range 5-3000 ppm, more preferably in the range 10-1000 ppm. For roses the optimum concentration may be in a range of 50-200 ppm.

An aspect is a method comprising the steps of:

providing a portion of packaging material, in particular a polymeric packaging material;

providing a portion of the produce;

forming, from the portion of packaging material and the portion of the produce, a closed package defining a package volume and containing in the package volume the portion of produce and a modified atmosphere;

wherein the modified atmosphere is modified with respect to the ambient atmosphere;

wherein the method comprises establishing a modified atmosphere in the package volume having an elevated ozone concentration at the time of closing the package, by filling the package with an ozone containing gas.

This method may be combined with any embodiment previously discussed. Providing the ozone as an ozone gas obviates provision of an ozone generator in the package and/or closing the package and treating the closed package to form ozone in the packages atmosphere. An ozone generator is expensive and complicates the package and/or the packaging process. E.g. a generator may cause a risk of negatively affecting the package and/or the produce by physical and/or chemical damage, and/or it may affect organoleptic characteristics of the produce. Further, the generator may have an inedible form and care must be taken to prevent accidental ingestion. Production of ozone from the package atmosphere may require including an ozone generator inside the package causing the aforementioned risks. Further this complicates and slows packaging processes. Further, most polymeric materials tend to degrade under ultra-violet radiation and/or high electric fields which are the most common and cost-effective methods of generating ozone.

Preferably the closed package resultant from the aforementioned methods is a controlled atmosphere package having a predetermined transmission rate for at least one of the components of the modified atmosphere, in particular at least one of oxygen, carbon dioxide, nitrogen, ethylene and water vapour, in particular the packaging material comprising one or more microperforations determining the transmission rate.

Thus, the shelf life of the produce may be extended as set out above.

The combination a controlled package with ozone turns out to be surprisingly effective in extending shelf life and quality; the initial decontamination appears to improve produce quality and health so that it benefits more from the CAP process and the CAP package can extend produce quality to such extend that the produce benefits from improved starting conditions, Together, the produce shelf is extended and produce quality is improved beyond what has been found before for ozone decontamination and for CAP- and MAP packaging alone.

As an example, in bunched tomatoes, the tomatoes themselves tend to benefit most from the ozone decontamination reducing botrytis growth whereas the stalks of the bunch tend to benefit most from the CAP aspects, retaining turgor and colour for well over 10 days, whereas ozone treatment without CAP may cause withering and spotting of the stalks.

It may be preferred that the modified atmosphere has a reduced oxygen concentration compared to the ambient atmosphere, e.g. between 6% and 10% oxygen, or even lower to, e.g., an O2 concentration <4%, e.g. <2% such as 0.5-1%, instead of about 21% in ambient air (volume percentages); and/or

the modified atmosphere has an elevated concentration of carbon dioxide compared to the ambient atmosphere, e.g. between 6% and 10% carbon dioxide, or even up to 20% instead of about 0,04% in ambient air (volume percentages). Note that the composition of ambient air at sea level is approximately (by volume): N₂ ca. 78.0%, O₂ ca. 20.9%, Ar ca. 0.9%, CO₂ ca. 0.03-0.04%, and further substances' presences being orders of magnitude less.

Such values have been found to provide good results for most produce. Particular values for particular produce may be determined in dependence of specific properties as discussed elsewhere herein.

The methods provided herein may comprise providing the packaging material with one or more microperforations for determining the transmission rate for at least one of the components of the modified atmosphere, in particular at least one of oxygen, carbon dioxide, nitrogen, ethylene and water vapour. Thus, the packaging material may be produced in one process sequence and/or in relation to particular method aspects, in particular to one or more properties of the produce and/or the package. This may obviate maintenance of stocks of packaging materials with different transmissibilities to account for variations in the produce and/or packaging requirements such as package sizes, portion sizes and/or demands related to storage and transport properties.

The method may comprise determining, e.g. measuring and calculating on the basis of measurement results, a respiration property of the produce to be packaged and determining on the basis of the determined respiration property of the produce to be packaged at least one of a composition of the modifying atmosphere, and/or, if applicable, a number and/or a size of the one or more microperforations to be made.

The produce may comprise cut flowers, e.g. roses, or flower bulbs, which are found to be sensitive to botrytis. However, suitable produce may also comprise one or more fruits like apples, pears, avocados, blueberries, citrus fruits, garlic, grapes, kiwis, mangos, melons, onions, papayas, pineapples, potatoes, stone fruits, strawberries, sweet potatoes, tomatoes (separate or bunched); vegetables like leafy vegetables, broccoli, brussels sprouts, carrots, cauliflower; mushrooms, like champignons, shiitake; fresh herbs like chives, coriander, rosemary, thymian, parsley.

Any embodiment discussed herein may comprise:

forming, from the portion of packaging material and the portion of the produce, a produce-containing pre-package form defining a pre-package volume for forming the closed package defining the package volume;

at least partly evacuating the pre-package volume;

establishing a temporary modified atmosphere in the pre-package volume having an ozone concentration of at least 5 ppm for a limited duration, e.g. in a range of 1 second to 5 minutes, preferably longer than 1 second e.g. about 10, 20 or 30 seconds and preferably shorter than 5 minutes e.g. about 3 minutes, 2 minutes or 1 minute, preferably in a range of 10-60 seconds e.g. 20-40 seconds;

at least partly evacuating the pre-package volume;

establishing the modified atmosphere having an elevated ozone concentration in the pre-package volume and closing the pre-package, thus providing the closed package containing the modified atmosphere in the package volume having an elevated ozone concentration of preferably at least 5 ppm at the time of closing the package;

wherein the steps of at least partly evacuating the pre-package volume and of establishing a temporary modified atmosphere in the pre-package volume may be called “flushing” which flushing may be omitted or may be repeated at least once.

Thus, the produce-containing pre-package may optionally be flushed at least once with an ozone-containing atmosphere prior to establishing the desired ozone-containing package. The flushing may be done with a different, in particular higher, ozone concentration than the elevated ozone concentration in the closed package. This may provide a particularly effective decontamination while the final atmosphere with elevated ozone concentration is not damaging to the produce.

Evacuation assists in providing the ozone at low pressure, e.g. the ozone being sucked into a packaging space in which the package is to be formed, e.g. containing the pre-package. This is beneficial since ozone tends to dissociate and react into regular molecular oxygen when compressed, causing loss of ozone, whereas formation of ozone costs significant amounts of energy.

The package may be temperature controlled, in particular cooled, after closure, preferably for at least 6-8 hours, e.g. over night. Ozone dissociation is temperature dependent; temperature controlling enables controlling a decay rate of the ozone concentration within the packages atmosphere. Cooling slows down ozone decay and slows down metabolic processes. Together the decontamination may have increased effectiveness, in particular reduction of ethylene, whereas the produce itself is believed to be less affected by the ozone.

Although any method embodiment described herein may be performed with a package in bag-form, e.g. a flowpack, a sealed tray is preferred; manufacturing such package for MAP is simpler and controlled more easily. The packaging material may be film, e.g. a polymer film, which may be a laminate film. Suitable polymer films are generally known and include films made of polyethylene, polypropylene, polyester, polyamide, and cellophane, in monolayers and laminates. The package may be formed as a flexible bag or pouch and/or at least part of it may be formed as a formed tray or box which may be sealed with a formed lid and/or a sealing film. A flexible bag or pouch may deform significantly under the shape and/or weight of the produce and may be suitable for robust produce and/or produce packaged in small elements, e.g. a bag of Brussels sprouts or cut lettuce, whereas a tray or a box may be substantially shape-retaining for protecting large and/or delicate produce like mushrooms or fruits such as apricots, berries etc. Further, a tray provides robustness to the package, protecting the packaged produce. This may be particularly relevant for packaging flowers.

The step of providing the modified atmosphere gas may comprise mixing at least one atmosphere modification gas, possibly several atmosphere modification gases, and the pressurised air to a gas mixture, and introducing at least a portion of the gas mixture into the package volume at elevated pressure. The mixing may be done in a mixing chamber and/or a manifold from which the mixed gas mixture is supplied, e.g. flown, to an actual location of providing the gas mixture in the package volume. The gas mixture may be supplied at a desired flow rate (e.g. determined in liters per minute or per hour) and/or at a desired pressure, e.g. the pressure of the pressurised air, the pressure of one or more of the atmosphere modification gases, or a summation of two or more of these pressures, but a modified pressure, e.g. further elevated pressure or in particular a reduced pressure may be preferred.

In an embodiment, the method comprises measuring at least one of the composition, an amount and a flow rate of at least one of air to be pressurised into the pressurised air, the pressurised air, the atmosphere modification gas and the gas mixture, prior to introducing the gas mixture into the packaging space.

In an embodiment, the step of forming the package containing the portion of produce and the atmosphere is performed in a packaging space, in particular a substantially enclosed space such as a bag filling tube and/or a tray sealing space, and the method comprises introducing the gas mixture in the packaging space, and wherein the packaging space comprises a gas inlet and a gas outlet and wherein the method comprises measuring at least one of a composition, an amount and a flow rate of gas at or near the gas outlet. The packaging space may be formed by an integral part of the device and/or by a removable part like a separate tray or carriage. This may increase processing speed.

These latter embodiments, which may also be used in methods of manufacturing a modified atmosphere package not relying on pressurised air but on other gas mixtures, enable quality control of the gas mixture and possibly adjustment of the composition of the gas mixture. In the former embodiment, features of the gas mixture entering the packaging space may be monitored. In the latter embodiment establishment and/or maintenance of a desired packaging space atmosphere composition may be monitored and loss of gas mixture from the packaging space may be prevented by timely reducing supplying one or more components of the gas mixture to the packaging space. Note that the gas outlet may be a produce inlet, in particular in a vertical packager with a produce chute, see below. The measurement and/or the optional adjustment may be done by an operator and/or automated by a controller.

The method may comprise providing the packaging material with one or more microperforations, for establishing a desired gas and/or humidity transmission rate through the packaging material different from respective transmission rates of the packaging material proper. Thus, the package may be formed as a Controlled Atmosphere Package in which a target package atmosphere, in particular an equilibrium atmosphere, is established and/or maintained by interaction, preferably a balance, between respiration of the produce on the one hand and gas exchange between the package atmosphere and the atmosphere surrounding the package on the other hand. The target package atmosphere, and thus the number and/or size of the microperforations, therefore will usually vary for different types of produce (flowers, vegetables, leafy vegetables, fruits and herbs, spices; washed, peeled, cut, otherwise processed or not processed) and may vary between different batches of the same type. One or more respiration properties of the produce may be determined of at least a portion of (a batch of) the produce to determine the target package atmosphere, e.g. which oxygen concentration, carbon dioxide concentration and/or ethylene concentration the target package atmosphere should have.

With such in mind, the method may comprise determining a respiration property of the produce to be packaged and determining on the basis of the determined respiration property of the produce to be packaged a composition of the modifying atmosphere, and—if applicable—a number of microperforations to be made and/or a size of the one or more microperforations to be made.

Providing the packaging material with one or more microperforations may be done with one or more mechanical perforators, e.g. needles which may optionally be heated, and/or electromagnetic perforators e.g. lasers. The latter have proven to be reliable tools for making microperforations suitable for packaging produce, with typical sizes in a range of 50 to 500 micrometer diameter, in particular in ranges of 70-120 micrometers, but ranges of 150-250 and/or of 250-350 micrometers may also be suitable. The number of microperforations may generally vary from 1 to 10 or 15 per package, some produce may require several tens or up to a few hundreds of microperforations. Monitoring, in particular imaging (photographing and/or filming) microperforations, in particular on-line, allows for quality control, adjustment and/or other feedback, e.g. by measuring an open area of some or, preferably, each microperforation.

An embodiment comprises modifying the atmosphere in the package to substantially the target package atmosphere. Thus, the produce may be brought at least close to its equilibrium state for prolonged quality and shelf life immediately on packaging. However, it may be preferred to modify intentionally the atmosphere of the package to a composition differing from the target package atmosphere, e.g. in view of particular storage and/or transportation criteria and/or circumstance benefiting a different package atmosphere.

Within the present principles method steps may suitably be performed in various sequences. E.g.

One option is: the volume of the package being formed may be filled with nitrogen or preferably with a mixture of nitrogen and pressurized air; the filling gas (mixture) may be forcefully introduced into the package volume-to-be and/or the package volume-to-be may first be (partly) evacuated to an underpressure and at least part of the filling gas (mixture) may be sucked into the package volume-to-be on the basis of the underpressure. Thus, the package volume-to-be is filled to a package pressure equal to the ambient pressure or less. Then, a mixture of oxygen and ozone is fed into the package volume to a concentration (possibly determined by an amount introduced) and/or predetermined pressure (typically at or near atmospheric pressure) and the package is closed, sealing in the gas mixture and thus providing the closed package defining a package volume and containing in the package volume the portion of produce and a modified atmosphere. This may be performed as a single gas-filling-and-sealing process sequence per single package or per groups of packages together, possibly preceded by a produce-filling step in the same sequence-per-package or sequence-per-group of packages together.

In such option, the underpressure preferably is a low or medium vacuum down to a predetermined underpressure of about 20% to 30% underpressure (i.e. 0.8-0.7 atmosphere remaining) or more, possibly down to about 30% of the ambient pressure (i.e. 70% underpressure, 0.3 atmosphere remaining). A desired underpressure may be provided by deeper evacuation and partial (re-) filling the package and/or by first (partly) filling the package volume and then partly (re-) evacuating it.

Also or alternatively, an option is: mixing ozone with nitrogen and/or with pressurized air and introducing the thus-formed gas mixture into the package volume, by suction from the package (also referred to as gassing) and/or by forced flowing of the thus-formed gas mixture into the package at a low force and/or overpressure (also referred to as flushing).

Also or alternatively, an option is: establishing a gas mixture having the modified atmosphere composition and concentrations of gases including oxygen, and subjecting the thus formed atmosphere modification gas mixture to a ozone converter for conversion of at least some of the oxygen in the mixture to ozone. The thus partly provided ozone-containing atmosphere modification gas mixture may then be introduced into the package (by overpressure and/or underpressure), and the package be sealed. Before this introduction and sealing, the package may have been flushed with the same or a similar gas mixture, possibly the same atmosphere modification gas mixture but except for the ozone conversion step.

Manipulation and/or introduction ozone may benefit from a pressure at or below atmospheric pressure; generally it is found that the lower the pressure the slower the decay of ozone and consequently the ozone concentration in a gas mixture.

Also in view of the preceding, with benefits and reasons applying mutatis mutandis, in an aspect an apparatus for manufacturing a modified atmosphere package is provided.

The apparatus comprises: a device for forming, from a portion of packaging material and a portion of produce, a closable package when closed defining a package volume and containing in the package volume the portion of produce and a modified atmosphere, i.e. modified with respect to the ambient atmosphere; a supply of an atmosphere modification gas and/or an atmosphere modifying gas mixture; a device for providing on the basis of the atmosphere modification gas and/or an atmosphere modifying gas mixture of the supply a gas mixture in the package volume for establishing the modified atmosphere in the package volume. The supply comprises a gas generator for generating one or more concentrated, enriched and/or purified gases or gas mixtures, compared to ambient air.

The supply may be configured to take in ambient air and to generate from the air taken in at least one of the atmosphere modification gases and/or an atmosphere modifying gas mixtures for establishing the atmosphere modifying gas mixture.

The gas generator may be configured to generate an atmosphere modification gas being essentially nitrogen, oxygen, argon, carbon dioxide or ethylene.

The apparatus may comprise a supply of ozone and the apparatus is configured for, based on the ozone, establishing a modified atmosphere in the package volume having an elevated ozone concentration.

The supply of ozone may comprises an ozone converter configured to convert oxygen into the ozone. The ozone converter may then be configured to take in ambient air and to convert oxygen in the air taken in into the ozone. Also or alternatively, the gas generator may be configured to generate oxygen or at least an oxygen-rich gas mixture, the ozone converter may be at least one of fluidly connected and fluidly connectable with the gas generator, and the ozone converter may be configured to convert at least part of the oxygen generated by the gas generator into the ozone.

In case the ozone is converted in the method, e.g. by provision of an ozone converter, the amount of oxyge

In an aspect an apparatus is provided, which comprises: a device for forming, from a portion of packaging material and a portion of produce, a closable package when closed defining a package volume and containing in the package volume the portion of produce and a modified atmosphere, i.e. modified with respect to the ambient atmosphere; a supply of ozone and a device for providing a gas mixture comprising the ozone in the package volume for establishing a modified atmosphere in the package volume having an elevated ozone concentration. The apparatus is characterised in that the supply of ozone provides the ozone as a gas into the package prior to closing and/or in that the elevated ozone concentration is at least 3 ppm at the time of closing the package, and preferably at most 5000 ppm at the time of closing the package

Such apparatus enables manufacturing a modified atmosphere package effectively and cost-efficiently enabling significantly extended shelf life and/or vase life in case of flowers.

The apparatus may comprise a supply of one or more atmosphere modifying gases and/or atmosphere modifying gas mixtures, for providing the modified atmosphere with a reduced oxygen concentration compared to the ambient atmosphere, e.g. between 6% and 10% oxygen, or even lower to, e.g., an oxygen concentration<4%, e.g. <2% such as 0.5-1%, instead of about 21% in ambient air (volume percentages) at the time of closing the package; and/or for providing the modified atmosphere with an elevated concentration of carbon dioxide compared to the ambient atmosphere, e.g. between 6% and 10% carbon dioxide, or even up to 20% instead of about 0.04% in ambient air (volume percentages) at the time of closing the package.

The device for providing the gas mixture may comprise a manifold from which a gas supply conduit may run to supply the gas mixture to an actual location of providing the gas mixture in the package volume, e.g. by flow due to a pressure of the air and/or the at least one atmosphere modification gas.

Although the packages may be closed by other means, e.g. by hand, the apparatus is preferably configured to close, e.g. seal, the package, to expedite the manufacturing process and possibly to increase hygiene.

The apparatus may comprise a supply of packaging material, e.g. a reel of packaging film and/or a supply of produce, e.g. filled hopper. The apparatus may comprise a transporter for empty packages and/or for filled packages. The apparatus may comprise a transporter for produce at least one of into the packaging material, onto the packaging material, and into a package.

In an embodiment the apparatus comprises a gas inlet for supplying the gas mixture in or near the package, and at least one gas sensor positioned upstream of the inlet, wherein the gas sensor is configured to detect at least one component of the gas mixture, in particular the at least one atmosphere modification gas. In this text “upstream” and “downstream” refer to the direction of gas flow, i.e. from the supply of pressurised air and/or the supply of at least one atmosphere modification gas toward the package and/or a gas outlet.

In an embodiment, the apparatus comprises a gas inlet for supplying the gas mixture in or near the package, wherein the apparatus comprises at least one of a gas outlet and a produce inlet for supplying the produce to the apparatus and/or to the package, positioned downstream of the gas inlet, and wherein the apparatus comprises at least one gas sensor positioned downstream of the inlet and upstream of, or at or near, the gas outlet and/or the produce inlet, wherein the at least one gas sensor is configured to detect at least one component of the gas mixture, in particular the at least one atmosphere modification gas.

These embodiments enable measuring the gas composition, e.g. for quality and/or feedback purposes. The latter embodiment may also reduce loss of valuable gas from the apparatus; note that a produce inlet may also form a gas outlet. In some embodiments a produce inlet may be provided with selectively closable passages as a lock for maintaining a packaging apparatus atmosphere within the packaging apparatus, modified with respect to the ambient atmosphere, and for reducing (atmosphere modification) gas loss through the produce inlet.

In an embodiment comprising at least one sensor, the apparatus may comprise a controller operably connected with the at least one gas sensor, preferably with plural gas sensors when present, and wherein the controller is operably connected with one or more regulators for controlling at least one of a composition and a flow of the gas mixture, in response to a signal from the at least one gas sensor, e.g. controller operable valves, and/or wherein the controller is operably connected with the device for forming a package, e.g. a supply of packaging material and/or a supply of produce.

Thus a feedback system may be provided; the composition and/or flow of the gas mixture may be regulated together with the device for forming a package, e.g. to accommodate for variations in packaging speed and/or to accommodate a packaging speed to variations in the composition and/or flow of the gas mixture. This facilitates improving one or more of quality control, production continuity, gas containment (i.e. reduction of gas loss and/or flushing out unwanted gas components), etc.

In an embodiment the apparatus comprises at least one of a vacuum pump, a perforator for providing the packaging material with one or more microperforations, a controller for the perforator and/or for control of (operation of) other parts of the apparatus may be provided, e.g. a camera. Also or alternatively, a sensor and/or controller for determining a target package atmosphere may be provided.

### BRIEF DESCRIPTION OF THE DRAWINGS

The above-described aspects will hereafter be more explained with further details and benefits with reference to the drawing showing an exemplary embodiment.

FIG. 1 schematically shows an embodiment of an apparatus and indicates at least part of an embodiment of a method.

### DETAILED DESCRIPTION OF EMBODIMENTS

It is noted that the drawings are schematic, not necessarily to scale and that details that are not required for understanding the present invention may have been omitted. The terms “upward”, “downward”, “below”, “above”, and the like relate to the embodiments as oriented in the drawings, unless otherwise specified. Further, elements that are at least substantially identical or that perform an at least substantially identical function are denoted by the same numeral, where helpful individualised with alphabetic suffixes.

Further, unless otherwise specified, terms like “detachable” and “removably connected” are intended to mean that respective parts may be disconnected essentially without destruction of either part, e.g. excluding structures in which the parts are integral (e.g. welded or molded as one piece), but including structures in which parts are attached by or as mated connectors, fasteners, releasable self-fastening features, etc.

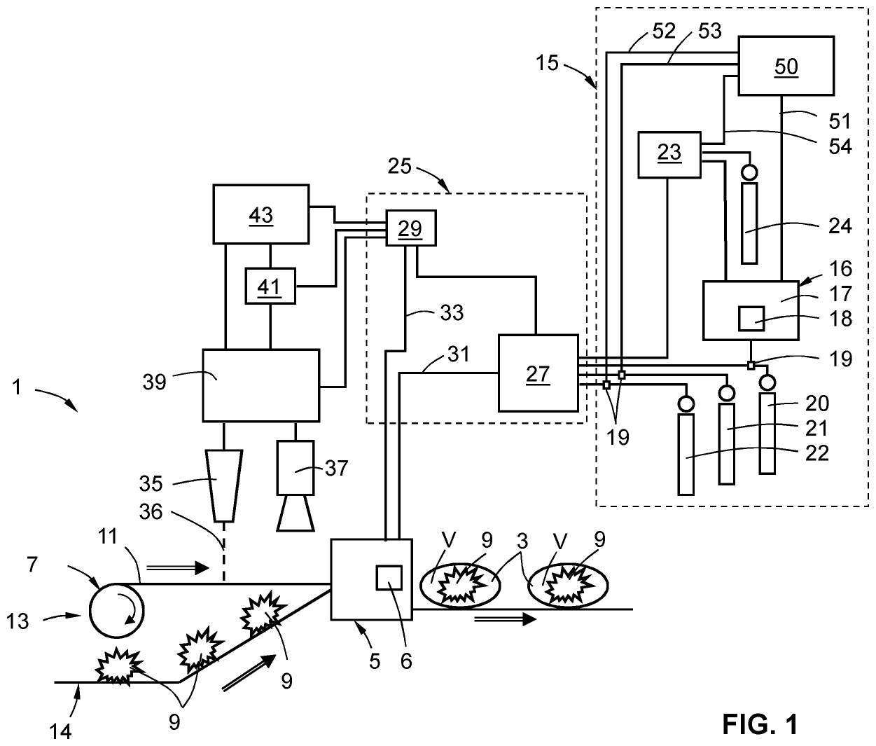

FIG. 1. shows schematically an apparatus 1 for manufacturing modified atmosphere packages 3. The apparatus 1 comprises a package forming device 5 for forming, from portions of packaging material 7 and portions of produce 9, modified atmosphere packages 3 each defining a package volume V and containing in the package volume V a portion of produce 9 and a modified atmosphere. Here, the packaging material is supplied as a web of a packaging film 11 on a roll 13 for forming packaging portions, e.g. bags or tray lids, but other forms and types of packaging material are also possible; e.g. two or more types of packaging material may be provided, such as trays and sealing film (not shown). In FIG. 1 the produce is provided as separate portions 9 by a produce transporter 14, but other ways of providing the produce as, or into, portions 9 may be used. Here, the apparatus 1 is configured to form and fill the packages 3 and also to close and separate them. The package forming device may comprise an ozone generator 6 for generating ozone within a package volume-to-be of a package as it is formed and/or filled, and/or for generating ozone within a package volume of a package once formed and filled.

The apparatus 1 comprises a supply 15 of one or more different atmosphere modification gases including an optional supply 16 of pressurised air, e.g. in the form of a compressor 17 provided with optional filters 18 and/or other pre-treatment portions e.g. humidity and/or temperature controllers. A supply tank 20 may be provided for pressurized air instead of the compressor 17 and/or as a buffer tank for the compressor 17, preferably (de-) connectable via a coupling and/or switching valve etc. generally indicated with reference symbol 19.

Further optional supplies of different atmosphere modification gases are optionally provided. E.g. CO₂ and N₂, are provided here in the form of gas bottles 21, 22.

The supply 15 further comprises an optional gas generator 50, for generating one or more concentrated and/or enriched and/or purified gases or gas mixtures, compared to ambient air, in particular nitrogen or at least a nitrogen enriched gas mixture. Also or alternatively, the gas generator may preferably generate one or more of oxygen, carbon dioxide and argon gas or at least an oxygen/carbon dioxide/argon enriched gas mixture, respectively. The desired gas (mixture), in particular nitrogen and/or oxygen, may be generated by chemical processes and/or by physical processes such as separation of the desired component from a source gas mixture which may preferably be ambient air.

The pressurised air supply 16 and the gas generator 50 may be fluidly connected (e.g. by a gas conduit 51) for supplying the one (16, 50) with a product from the other (50, 16) or the other way around.

The generated gas or gases may be fed to the package forming device 5 (see below) and/or stored in one or more optional buffer tanks, e.g. supply tanks 21, 22, which may be (de-) connectable via a coupling and/or a switching valve etc. 19.

The apparatus 1 further is provided with an optional supply 23 of ozone, here in the form of an ozone generator e.g. an oxygen supply and UV-light sources and/or spark dischargers. The oxygen for ozone formation may be provided from any suitable source such as a separate tank 24 as shown and/or a gas generator 50 (e.g. by a gas conduit 54). Also or alternatively, the ozone generator 23 may form the ozone from oxygen present in the pressurised air from the pressurised air supply 16 and/or from oxygen present in ambient air taken in by the ozone generator 23. A total amount of ozone in a package atmosphere may be provided by a combination of ozone supplied from the ozone generator 23 and ozone generated within the package using the ozone generator 6.

One or more of atmosphere modification gas(es) may be supplied pressurised so that they may be transported by flowing under their own pressure so that one or more propellers are not needed; however, these may be provided. Also or alternatively, one or more suction devices, e.g. suction fans, may be provided also for transporting one or more of the atmosphere modification gas(es). Note that a gas flow of one gas (mixture) may be used for affecting and/or introducing a second gas, e.g. by use of a venturi effect.

The apparatus 1 comprises a device 25 for providing a gas mixture of one or more of the atmosphere modification gases from (one or more of the various supplies 16, 20, 21, 22, 23, 50 of) the supply 15 in the package volume V of each package 3 as that is formed.

Here, the device 25 comprises a manifold 27 connected by a gas supply conduit 31 to the package forming device 5. The manifold 27 and an optional feedback sensor signal line 33 are connected to an optional controller 29. A controller, e.g. the controller 29, may be connected to one or more of the pressurised air supply 16, the gas generator 50, the ozone generator 23, and/or to one or more gauges, valves, switches, pressure regulators, controls etc. for operating the respective portions of the apparatus.

Note that, although not shown, a gas circulation system may be provided for circulating at least a portion of the gas mixture through at least part of the supply 15 and possibly through at least part of the package forming device and along a suitable gas sensor for at least one of, gradually increasing and/or stabilizing a gas component concentration and/or a gas composition, in particular with respect to an oxygen and/or ozone concentration.

As indicated in FIG. 1, the apparatus 1 further comprises a perforator, here a (possibly pulsed) laser 35 providing a (pulsed) laser beam 36, and a camera 37 for imaging microperforations and/or other control processes. The laser 35 and the camera 37 are operably connected with a perforation controller 39 for operational control, quality control and/or feedback control of the laser 35. The controller 39 may be programmable for determining one or more of the number, size and positions of the microperforations.

Further, not shown in any detail, the apparatus 1 may comprise a detector 41 and a calculator 43 configured to determine, e.g. by measuring and calculating on the basis of measurement results, one or more respiration properties, e.g. an O₂ consumption and/or CO₂-production of the produce to be packaged and, based on that/those, determining one or more of a composition of the target modified atmosphere, a composition of the modifying atmosphere, a number and/or size of one or more microperforations (to be) made in the packaging material of the package(s).

Two or more of the gas mixture controller 29, the perforation controller 39, the detector 41, the calculator 43 and an optional controller for the ozone generator 6 may be interconnected and/or integrated in one combined controller.

The package forming device 5 may be a tray sealing device, forming packages from a tray, which may have the form of a box, a shell or other receptacle, and providing the tray with a lid; the lid may be a film or another box, shell or similar object. The lid may be sealed onto the tray by heat sealing.

Preferably, the package forming device 5 is a MAP tray sealer, comprising an enclosed packaging space at least partly defined by one or more openable and closable covers. The produce portions 9 may be provided as separate portions to be placed in a tray in the device 5 or they may be supplied as portions 9 in individual trays (not shown).

In a typical example, one or more produce portions 9, each in a tray without a lid or with an only partly closed lid thus forming an open pre-package are placed in the packaging space;

the packaging space is closed off from the environment; the atmosphere in the packaging space and the one or more pre-packages therein is at least partly evacuated, e.g. to an underpressure relative to ambient pressure of about −0.3 bar, or lower like about -0,5 bar, or even as low as about −0.75 bar (i.e. about 70 kPa, about 50 kPa and, respectively about 25 kPa absolute pressure remaining; 1 bar=100 kPa);

a flushing gas mixture comprising ozone at an elevated concentration, e.g. pressurised air containing ozone at a concentration in a range 7-5000 ppm is introduced in the packaging space and the one or more pre-packages therein;

the thus formed flushing atmosphere is maintained for a limited time, e.g. for a time in a range of 5-120 seconds;

the one or more pre-packages therein are again at least partly evacuated as before,

the flushing and subsequent evacuation steps may be omitted or be repeated one or more times with the same or different ozone-containing gas mixtures;

an atmosphere modification gas mixture comprising ozone at an elevated concentration, e.g. containing ozone at a concentration in a range 7-5000 ppm is introduced in the packaging space and the one or more pre-packages therein, the atmosphere modification gas mixture may comprise air or another gas mixture, e.g. having reduced oxygen concentration and elevated carbon dioxide concentration compared to the ambient atmosphere;

the packages are closed, wherein the packaging material preferably is provided with one or more microperforations, or has been provided with one or more microperforations previously;

the packaging space is again evacuated and/or flushed to remove remaining ozone, e.g. being flushed with a gas that is at least substantially ozone-free and/or strongly reactive with ozone, and the packaging space is opened freeing the closed package(s) 3. The thus provided package(s) 3 may be refrigerated, stored and/or transported for sale.

For increasing processing speed, during establishing of the modified atmosphere in a (pre-)package volume and/or any optional associated flushing steps, a portion of oxygen may be converted into ozone and stored for use in a subsequent instance of establishing a modified atmosphere in a (pre-)package volume and/or any optional associated flushing steps.

It is noted that any package as presently provided may contain smaller packages. Further, such smaller packages may also be according to the present concepts.

As an example, 9 bunches of cut roses (variety “H3O”) were bought from a wholesaler, fresh from the morning's flower auction. The bunches were put in regular water and left at room temperature for three days without treatment. Then they were heavily contaminated with botrytis mold taken from (purposefully) molded strawberries. A packaging setup was made comprising a tubular polymeric packaging foil and an ozone generator. Bunches of roses were individually packaged in a portion of the packaging foil; the filled pre-packs were flushed with a mixture of ozone and air and closed, while flushing the package so that each package had a well-established elevate ozone concentration. Half of the thus-packed bunches were chilled to 3 degrees Centigrade for 18 hours and thereafter maintained at 20 degrees Centigrade, the other thus-packed bunches were continuously maintained at 20 degrees Centigrade. One bunch was packaged without ozone treatment and also maintained at 20 degrees Centigrade to act as a reference. After a total of 7 days from the date of packaging the packages were opened and the flowers were put into vases with regular drinking water at room temperature and maintained at room temperature adjacent each other. 3 days later the (vases of) bunches were individually assessed by two test persons regarding appearance and condition of the flowers. The results are presented in the following table:

TABLE 1
test results of ozone-treated roses

| Bunch | Chilled | Warm | Quality |
|---|---|---|---|
| [nr] | [PPM O₃] | [PPM O₃] | [ranking] |
| 1 | | 200 | 1 (good) |
| 2 | 50 | | 2 |
| 3 | 7 | | 3 |
| 4 | | 50 | 4 |
| 5 | 200 | | 5 |
| 6 | | 7 | 6 |
| 7 | | 1000 | 7 |
| 8 | 1000 | | 8 |
| 9 | | 0 = reference | 9 (bad) |

Observations and conclusions were that:

The untreated bunch used as reference was heavily affected with botrytis and mildew and had an unacceptable appearance.

Afflictions of botrytis and mildew were less for any ozone-condition, already clearly so at 7 ppm ozone.

The best bunch still had an acceptable appearance for display.

The chilling step directly after packaging leads, on average, to better results.

For chilled bunches ozone damage may be identified from 50 ppm ozone, and increasing with increased ozone concentration. For room-temperature bunches ozone damage may be identified from 200 ppm ozone, and increasing with increased ozone concentration.

The disclosure is not restricted to the above described embodiments which can be varied in a number of ways within the scope of the claims. For instance, the package may be provided with an overpressure relative to the ambient atmosphere. Packages may be supported on a transporter during filling. Packages may be closed by hand. Gas composition sensors may be provided and placed differently and/or be formed as an optical detector. Weighing devices may be added. A (micro)perforator may be absent.

Elements and aspects discussed for or in relation with a particular embodiment may be suitably combined with elements and aspects of other embodiments, unless explicitly stated otherwise.

1. A method of packaging respiring produce, comprising the steps of:
providing an apparatus for manufacturing a modified atmosphere package;
providing a portion of packaging material;
providing a portion of the produce;
forming, using the apparatus, from the portion of packaging material and the portion of the produce, a closed package defining a package volume and containing in the package volume the portion of produce and a modified atmosphere;
wherein the modified atmosphere is modified with respect to the ambient atmosphere;
characterised in that the method comprises generating a gas with the apparatus, said gas being one or more concentrated, enriched and/or purified gases or gas mixtures, compared to ambient air and establishing the modified atmosphere on the basis of the generated gas.

2. The method according to claim 1, wherein the step of generating the gas comprises taking in ambient air and generating from the air taken in at least one atmosphere modification gas and/or an atmosphere modifying gas mixture for establishing the atmosphere modification gas and/or atmosphere modifying gas mixture.

3. The method according to claim 1, wherein the step of generating the gas comprises generating an atmosphere modification gas being essentially nitrogen, oxygen, argon, carbon dioxide or ethylene.

4. The method according to claim 1, wherein the gas comprises ozone and wherein the method further comprises establishing the modified atmosphere in the package having an elevated ozone concentration in the package volume relative to an ozone concentration of ambient air.

5. The method according to claim 4, wherein the elevated ozone concentration is an ozone concentration of at least 3 ppm at the time of closing the package.

6. The method according to claim 4, wherein the ozone concentration is at most 5000 ppm at the time of closing the package.

7. A method according to claim 1, wherein the method comprises establishing the modified atmosphere in the package volume having an elevated ozone concentration, relative to an ozone concentration of ambient air, at the time of closing the package, by filling the package with an ozone containing gas.

8. The method according to claim 1, wherein the closed package is a controlled atmosphere package having a predetermined transmission rate for at least one component of the modified atmosphere.

9. The method according to claim 1, comprising providing the packaging material with one or more microperforations for determining a transmission rate for at least one compontent of the modified atmosphere.

10. The method according to claim 1, comprising determining a respiration property of the produce to be packaged and determining on the basis of the determined respiration property of the produce to be packaged at least one of:
a composition of the modifying atmosphere, and
number and/or a size of one or more microperforations to be made.

11. The method according to claim 1, wherein the produce comprises cut flowers, or flower bulbs.

12. The method according to claim 1, wherein the method comprises:
forming, from the portion of packaging material and the portion of the produce, a produce-containing pre-package defining a pre-package volume for forming the closed package defining the package volume;
at least partly evacuating the pre-package volume;
establishing the modified atmosphere having an elevated ozone concentration in the pre-package volume and closing the pre-package, thus providing the closed package containing the modified atmosphere in the package volume having an elevated ozone concentration of at least 5 ppm at the time of closing the package.

13. The method according to claim 12, further comprising, prior to the step of at least partly evacuating the pre-package volume,
an additional step of at least partly evacuating the pre-package volume; and
a step of establishing a temporary modified atmosphere in the pre-package volume having an ozone concentration of at least 5 ppm for a limited duration;
wherein the additional step of at least partly evacuating the package volume and the step of establishing a temporary modified atmosphere in the package volume may be repeated at least once.

14. The method according to claim 1, wherein the package is temperature controlled after closure.

15. The method according to claim 1, wherein the package is formed by tray sealing.

16. The method according to claim 1, wherein the method further comprises measuring at least one of the composition, an amount and a flow rate of at least one of ozone and the gas mixture when introducing the gas mixture into the packaging space; and/or
wherein the step of forming the package containing the portion of produce and the modified atmosphere is performed in a packaging space comprising a gas inlet and a gas outlet, and the method comprises introducing the gas mixture into the package volume in the packaging space, the method then further comprising measuring at least one of a composition, an amount and a flow rate of gas at or near the gas inlet and/or at or near the gas outlet.

17. An apparatus for manufacturing a modified atmosphere package, comprising:
a device for forming, from a portion of packaging material and a portion of produce, a closable package, when closed defining a package volume and containing in the package volume the portion of produce and a modified atmosphere;
a supply of an atmosphere modification gas and/or an atmosphere modifying gas mixture;
a device for providing on the basis of the atmosphere modification gas and/or the atmosphere modifying gas mixture of the supply a gas mixture in the package volume for establishing the modified atmosphere in the package volume,
wherein the supply comprises a gas generator for generating one or more concentrated, enriched and/or purified gases or gas mixtures, compared to ambient air.

18. The apparatus of claim 17, wherein the supply is configured to take in ambient air and to generate from the ambiet air taken in at least one of the atmosphere modification gases and/or the atmosphere modifying gas mixtures for establishing the atmosphere modifying gas mixture.

19. The apparatus of claim 17, wherein the gas generator is configured to generate an atmosphere modification gas being essentially nitrogen, oxygen, argon, carbon dioxide or ethylene.

20. The apparatus of claim 17, wherein the apparatus comprises a supply of ozone and the apparatus is configured for, based on the ozone, establishing a modified atmosphere in the package volume having an elevated ozone concentration.

21. The apparatus of claim 20, wherein the supply of ozone comprises an ozone converter configured to convert oxygen into the ozone,
wherein the ozone converter is configured to take in ambient air and to convert oxygen in the ambient air taken in into the ozone; and/or
wherein the gas generator is configured to generate oxygen or at least an oxygen-rich gas mixture, the ozone converter is at least one of fluidly connected and fluidly connectable with the gas generator, and the ozone converter is configured to convert at least part of the oxygen generated by the gas generator into the ozone.

22. An apparatus for manufacturing a modified atmosphere package comprising:
a device for forming, from a portion of packaging material and a portion of produce, a closable package, which when closed defines a package volume containing in the package volume the portion of produce and a modified atmosphere;
a supply of ozone; and
a device for providing a gas mixture comprising ozone from the supply of ozone in the package volume for establishing a modified atmosphere in the package volume having an elevated ozone concentration, characterised in that the elevated ozone concentration is at least 3 ppm at the time of closing the package.

23. The apparatus according to claim 22, wherein the supply of ozone provides the ozone as a gas into the package prior to closing.

24. The apparatus according to claim 17, comprising a supply of one or more atmosphere modifying gases and/or atmosphere modifying gas mixtures, for providing the modified atmosphere with a reduced oxygen concentration compared to the ambient atmosphere at the time of closing the package; and/or
for providing the modified atmosphere with an elevated concentration of carbon dioxide compared to the ambient atmosphere at the time of closing the package.

25. The apparatus according to claim 17, wherein the apparatus is configured to close the package, and/or
wherein the apparatus comprises at least one of,
a vacuum pump,
a perforator for providing the packaging material with one or more microperforations,
a controller for the perforator, when present,
a camera, and
a system for determining a target package atmosphere.
